(19) United States
(12) Patent Application Publication
(10) Pub. No.: US 2025/0139959 A1
(43) Pub. Date: May 1, 2025

(54) DETECTING OBJECTS IN IMAGES BY GENERATING SEQUENCES OF TOKENS

(71) Applicant: Google LLC, Mountain View, CA (US)

(72) Inventors: Ting Chen, Mountain View, CA (US); Saurabh Saxena, Mississauga (CA); Yi Li, Oakville (CA); Geoffrey E. Hinton, Toronto (CA); David James Fleet, Toronto (CA)

(21) Appl. No.: 18/690,550

(22) PCT Filed: Sep. 19, 2022
(86) PCT No.: PCT/US2022/044031

§ 371 Date: Mar. 8, 2024

Related U.S. Application Data
(60) Provisional application No. 63/245,783, filed on Sep. 17, 2021.

(51) Int. Cl. G06V 10/82; G06V 10/764; G06V 10/774; G06V 10/776; G06V 20/70

(52) U.S. Cl. CPC G06V 10/82; G06V 10/764; G06V 10/774; G06V 10/776; G06V 20/70

(57) ABSTRACT

Methods, systems, and apparatus, including computer programs encoded on computer storage media, for object detection using neural networks. In one aspect, one of the methods includes obtaining an input image; processing the input image using an object detection neural network to generate an output sequence that comprises respective token at each of a plurality of time steps, wherein each token is selected from a vocabulary of tokens that comprises (i) a first set of tokens that each represent a respective discrete number from a set of discretized numbers and (ii) a second set of tokens that each represent a respective object category from a set of object categories; and generating, from the tokens in the output sequence, an object detection output for the input image.

### CROSS-REFERENCE TO RELATED APPLICATION

This application claims the benefit of U.S. Provisional Application No. 63/245,783, filed on Sep. 17, 2021. The disclosure of the prior application is considered part of and is incorporated by reference in the disclosure of this application.

### BACKGROUND

This specification relates to processing inputs using neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., another hidden layer or the output layer. Each layer of the network generates an output from a received input in accordance with current values of a respective set of parameters.

### SUMMARY

This specification describes a system implemented as computer programs on one or more computers in one or more locations that detects objects in an input image by processing the image using a neural network to generate an output sequence of tokens.

The subject matter described in this specification can be implemented in particular embodiments so as to realize one or more of the following advantages.

Existing object detection methods need to be highly customized and have complex architectures, making it difficult to integrate them into a larger system. The described techniques, on the other hand, use an object detection neural network that produces a sequence of discrete tokens that correspond to object descriptions. The object detection neural network has a simple architecture and can therefore be readily incorporated into perception systems or extended to different domains or applications. Moreover, despite the simplicity of the architecture, because the described techniques produce a sequence of discrete tokens that correspond to object descriptions (bounding boxes and class labels), the object detection neural network can achieve performance that matches or exceeds that of much more complex systems that have been heavily engineered for a particular object detection task.

The details of one or more embodiments of the subject matter of this specification are set forth in the accompanying drawings and the description below.

Other features, aspects, and advantages of the subject matter will become apparent from the description, the drawings, and the claims.

### BRIEF DESCRIPTION OF THE DRAWINGS

FIG. 1 is a diagram of an example object detection system.

FIG. 2 is a flow diagram of an example process for detecting objects in an input image.

FIG. 3 is a diagram that shows examples of object detection outputs generated using the object detection neural network.

FIG. 4 is a flow diagram of an example process for training the object detection neural network.

FIG. 5 is a diagram that shows the training of the object detection neural network on a training example.

Like reference numbers and designations in the various drawings indicate like elements.

### DETAILED DESCRIPTION

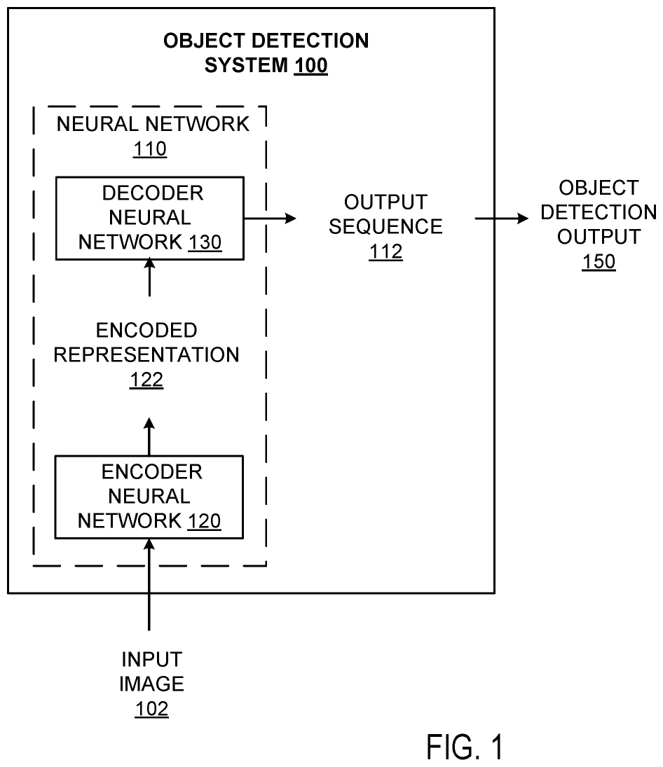

FIG. 1 is a diagram of an example object detection system 100. The object detection system 100 is an example of a system implemented as computer programs on one or more computers in one or more locations, in which the systems, components, and techniques described below can be implemented.

The object detection system 100 is a system that receives an input image 102 and detects objects in the input image 102 by processing the image 102 using an object detection neural network 110 to generate an object detection output 150 for the input image 102.

The object detection output 150 identifies one or more bounding boxes in the input image 102 that each correspond to a detected object, i.e., are predicted to contain a depiction of the detected object and, for each of the bounding boxes, an object category from a set of object categories to which the detected object in the bounding box belongs.

More specifically, the system 100 obtains an input image 102.

The system 100 processes the input image 102, i.e., processes the intensity values of the pixels of the input image 102, using the object detection neural network 110 to generate an output sequence 112 that includes a plurality of tokens.

Each token in the sequence is selected from a vocabulary of tokens that includes (i) a first set of tokens that each represent a respective discrete number from a set of discretized numbers and (ii) a second set of tokens that each represent a respective object category from a set of object categories. The tokens in the vocabulary can be represented in any appropriate way, e.g., as integers or other alphanumeric symbols that are distinguishable from one another.

More specifically, the system discretizes the numbers used to represent the coordinates of any given point in the input image 102 into multiple bins, with each of the bins corresponding to a respective one of the tokens in the first set of tokens. As a particular example, the system can discretize the range of values between zero and the height or width of the image in pixels into a fixed number of evenly spaced bins, so that each bin corresponds to a different subset of the pixel indices that can be used to represent the coordinates of a point (in pixels) within the image. Thus, if the input images are 600 pixels×600 pixels and there are 600 bins, each bin will correspond to a different pixel index from 1 to 600. If the input images are 600×600 and there are 300 bins, each bin will correspond to a different set of two pixel indices from 1 to 600.

Thus, each token in the first set of tokens represents a different bin in a discretization of the possible coordinate values for a pixel in the image and can be mapped to a different quantized coordinate value, e.g., a representative value for the bin represented by the token. For example, the representative value can be the average of the end points of the bin or one of the two end points of the bin. This quantization scheme of the coordinates allows the system to use a relatively small vocabulary to represent possible pixel coordinates while maintaining high precision.

For the second set of tokens, the system can assign a different, unique token to each object category in the set.

Thus, as a particular example, when there are 600 bins in the quantization scheme and 100 object categories and tokens are represented as integers, the vocabulary can include tokens 1-600 that represent the 600 possible quantized coordinates and tokens 601-700 that represent the 100 object categories.

Optionally, as will be described in more detail, the vocabulary can also include one or more additional tokens in addition to those described above.

Generally, the object detection neural network 110 is configured to generate the output sequence across multiple time steps.

At each time step, the neural network 110 is configured to generate a score distribution over the tokens in the vocabulary for each time step conditioned on (i) the input image and (ii) the tokens at any earlier time steps in the output sequence.

Thus, at each time step during the generation of the output sequence 112, the system 100 selects the respective token at the time step in the output sequence 112 using the respective score distribution generated by the object detection neural network 110 for the time step.

As one example, the system 100 can greedily select the highest scoring token.

As another example, the system 100 can select the respective token by sampling a token in accordance with the score distribution. As a particular example, the system can sample a token in accordance with the score distribution using nucleus sampling.

As a particular example, the object detection neural network 110 can include an encoder neural network 120 and a decoder neural network 130.

The encoder neural network 120 can be configured to process the input image 102 to generate an encoded representation 122 of the input image 102. The encoded representation 122 is a sequence that includes a plurality of encoded vectors that collectively represents the input image 102.

The encoder neural network 120 can be any appropriate image encoder neural network that receives the intensity values of the pixels of the image 102 and encodes them into hidden representations. Examples of such encoders include convolutional neural networks, Transformer neural network, or neural networks that include both convolutional layers and self-attention layers. An example of a convolutional neural network that can be used as the encoder is described in Kaiming He, Xiangyu Zhang, Shaoqing Ren, and Jian Sun. Deep residual learning for image recognition. In Proceedings of the IEEE Conference on Computer Vision and Pattern Recognition, pp. 770-778, 2016. An example of a Transformer neural network that can be used as the encoder is described in Alexey Dosovitskiy, Lucas Beyer, Alexander Kolesnikov, Dirk Weissenborn, Xiaohua Zhai, Thomas Unterthiner, Mostafa Dehghani, Matthias Minderer, Georg Heigold, Sylvain Gelly, et al. An image is worth 16×16 words: Transformers for image recognition at scale. In International Conference on Learning Representations, 2020. An example of a neural network that includes both convolutional layers and self-attention layers that can be used as the encoder is described in Nicolas Carion, Francisco Massa, Gabriel Synnaeve, Nicolas Usunier, Alexander Kirillov, and Sergey Zagoruyko. End-to-end object detection with transformers. In European Conference on Computer Vision, pp. 213-229. Springer, 2020.

When the last layer of the encoder 120 is a convolutional layer that generates a feature map, the system 100 can generate the encoded representation 122 by flattening the feature map into a sequence of vectors. When the last layer of the encoder 120 is an attention layer, the system 100 can directly use the outputs of the attention layer as the encoded representation 122.

The decoder neural network 130 is configured to process the encoded representation 122 of the input image 102 to generate the output sequence 112.

In particular, the decoder 130 can be an auto-regressive decoder neural network that, at each time step, processes the tokens at any earlier time steps in the output sequence 112 while conditioned on the encoded representation 122 of the input image 102 to generate a respective score distribution for the time step. The score distribution includes a respective score, e.g., a probability or a logit, for each token in the vocabulary.

As a particular example, the decoder 130 can be a Transformer decoder that applies causal self-attention over the already generated tokens and cross-attention into the encoded representation 122. That is, the decoder 130 can include both self-attention layers that apply causal self-attention over representations of the already generated tokens and cross-attention layers that cross-attend into the encoded representation 122.

Examples of such Transformer decoders that can be used as the decoder 130 are described in Colin Raffel, Noam Shazeer, Adam Roberts, Katherine Lee, Sharan Narang, Michael Matena, Yanqi Zhou, Wei Li, and Peter J Liu. Exploring the limits of transfer learning with a unified text-to-text transformer. arXiv preprint arXiv:1910.10683, 2019 and Alec Radford, Karthik Narasimhan, Tim Salimans, and Ilya Sutskever. Improving language understanding by generative pre-training. 2018.

The system 100 then generates, from the tokens in the output sequence 112, the object detection output 150. That is, the system 100 maps the tokens in the output sequence 112 to data identifying one or more bounding boxes in the input image and, for each bounding box, a respective object category from the set of object categories to which an object depicted within the bounding box belongs.

For each bounding box, the data identifying the bounding box specifies the position of the bounding box within the image. As one example, the data identifying the bounding box can specify the coordinates of two or more of the corners of the bounding box. As another example, the data identifying the bounding box can specify the coordinates of the center of the bounding box and the height and width of the bounding box.

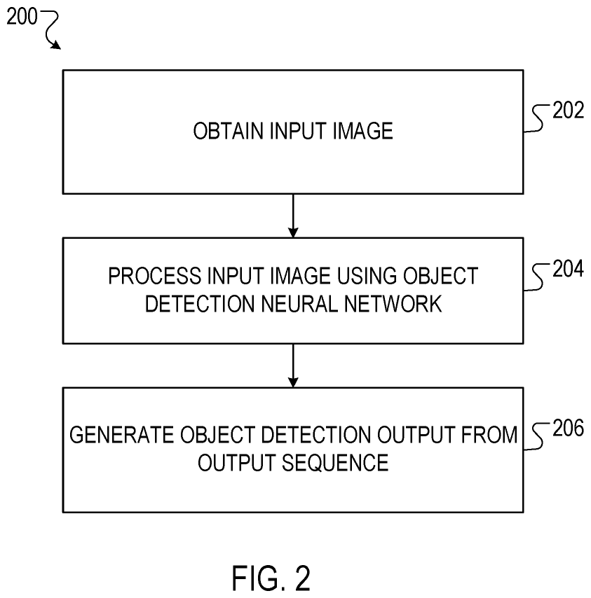

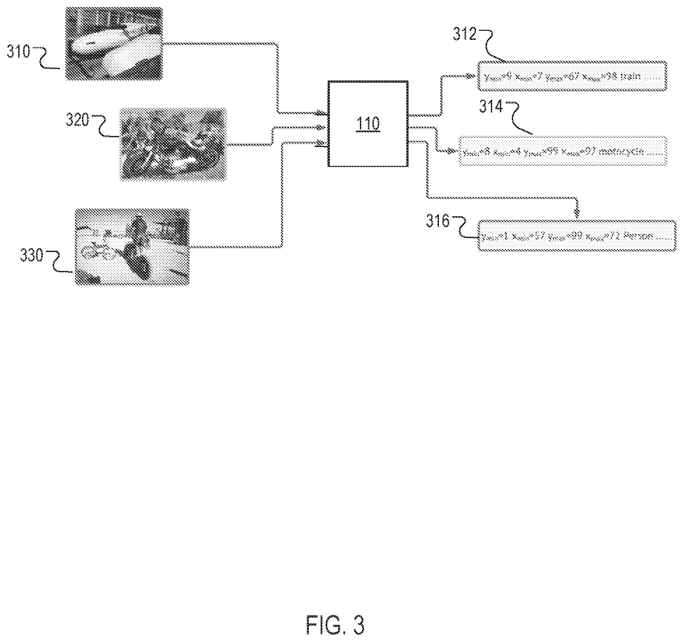

Generating the object detection output 150 from the output sequence 112 is described in more detail below with reference to FIGS. 2 and 3.

Thus, the object detection neural network 110 generates an output sequence 112 of discrete tokens that can be directly mapped to an object detection output by the system 100. By generating the object detection output in this manner, the system 100 does not need to be highly customized or use neural networks with complex architectures and can be readily integrated into a larger system.

As a particular example, the system 100 can be part of a perception system embedded within an agent, e.g., a robot or an autonomous vehicle, that processes images and optionally other sensor data collected by sensors of the agent and the object detection output can be used by the perception system or other software on-board the agent to control the agent as the agent navigates through the environment.

As another particular example, the system 100 can be part of a perception system embedded within or in communication with a different type of device that processes sensor data, e.g., a camera monitoring system, a mobile phone, and so on. The object detection outputs generated by the system 100 can be used as part of a pre-processing stage before images are displayed to a user or can be used to automatically trigger other actions.

As yet another particular example, client devices can interact with the system 100 through an application programming inference (API), e.g., a web-based API. In particular, client devices can submit an API call that includes or identifies an image to be analyzed and the system 100 can provide, in response, data identifying the object detection output. For example, the system 100 can format the object detection output in a specified format, e.g., as a JavaScript Object Notation (JSON) file or as a file in another type of data-interchange format, and provide the file in response to the API call.

Prior to using the neural network 110 to detect objects, the system 100 or another training system trains the neural network 110 on training data that includes multiple training examples.

Each training example includes an input training image and a ground truth object detection output that identifies ground truth bounding boxes within the image and a respective ground truth object category for each bounding box.

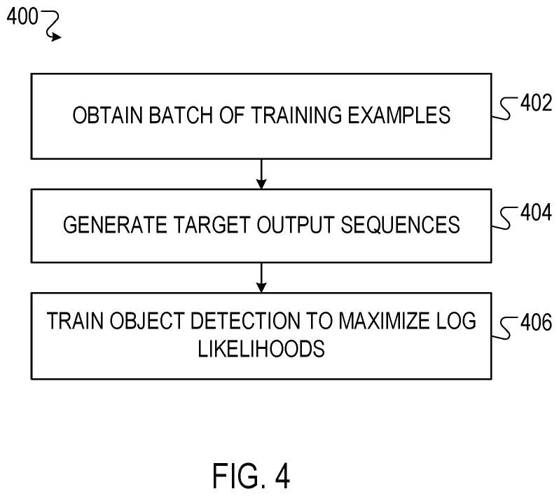

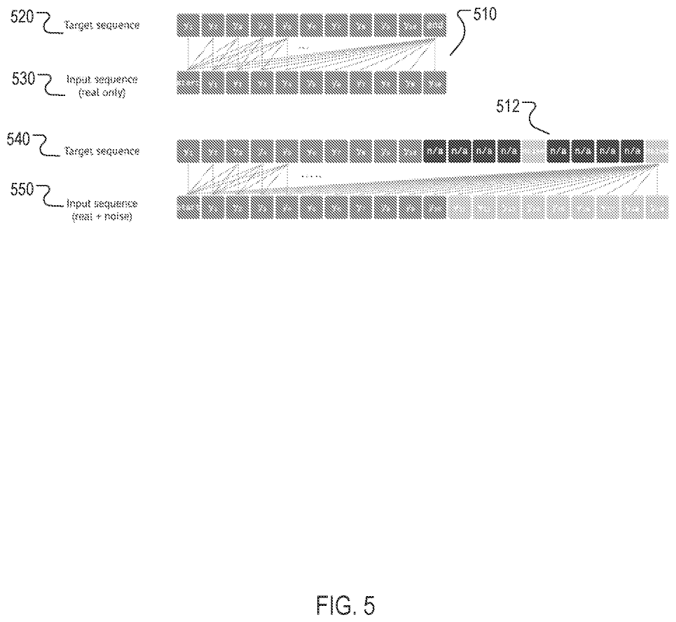

Training the neural network 110 will be described in more detail below with reference to FIGS. 4 and 5.

FIG. 2 is a flow diagram of an example process 200 for generating an object detection output for an input image. For convenience, the process 200 will be described as being performed by a system of one or more computers located in one or more locations. For example, an object detection system, e.g., the object detection system 100 depicted in FIG. 1, appropriately programmed in accordance with this specification, can perform the process 200.

The system obtains an input image (step 202).

The system processes the input image using an object detection neural network to generate an output sequence (step 204).

As described above, the output sequence includes a respective token at each of a plurality of time steps. Each token is selected from a vocabulary of tokens that includes (i) a first set of tokens that each represent a respective discrete number from a set of discretized numbers and (ii) a second set of tokens that each represent a respective object category from a set of object categories.

The vocabulary can also optionally include additional tokens.

For example, the vocabulary can include an end-of-sequence (EOS) token.

As another example, the vocabulary can include a “noise” token that represents a noise object category that is not included in the set of object categories (and therefore does not represent any actual objects that may be depicted in input images). The “noise” token can be added to the vocabulary prior to the training of the neural network in order to improve the effectiveness of the training, as will be described in more detail below.

Generally, the object detection neural network is configured to generate the output sequence across multiple time steps.

At each time step, the neural network is configured to generate a score distribution over the tokens in the vocabulary for each time step conditioned on (i) the input image and (ii) the tokens at any earlier time steps in the output sequence.

Thus, at each time step during the generation of the output sequence, the system selects the respective token at the time step in the output sequence using the respective score distribution generated by the object detection neural network for the time step.

As one example, the system can greedily select the highest scoring token.

As another example, the system can select the respective token by sampling a token in accordance with the score distribution. As a particular example, the system can sample a token in accordance with the score distribution using nucleus sampling.

As yet another example, when the vocabulary includes the noise token, the system can determine whether the noise token was selected at any given time step and, if so, replace the noise token with the highest scoring token from the second set of tokens. That is, in response to determining that the noise token was selected, the system selects, from only the tokens in the second set of tokens, the token with the highest score to replace the noise token.

In some implementations, the system continues adding tokens to the output sequence until the end of sequence (EOS) token is selected. In some other implementations, the system continues adding tokens to the output sequence until the output sequence has a fixed length, i.e., has a maximum number of tokens. In yet other implementations, the system continues adding tokens to the output sequence until the EOS token has been selected or until the output sequence has the fixed length, whichever occurs first.

The system generates, from the tokens in the output sequence, an object detection output, i.e., data identifying one or more bounding boxes in the input image and, for each bounding box, a respective object category from the set of object categories to which an object depicted in the bounding box belongs (step 206).

In particular, because of the way that the neural network is trained, the output sequence includes a respective subsequence for each of one or more bounding boxes in the input image.

The subsequence for a given bounding box includes tokens from the first set of tokens and a token from the second set of tokens. For example, the subsequence can include five total tokens: four tokens from the first set and one token from the second set. As a particular example, the subsequence can include four tokens from the first set followed by one token from the second set.

In some cases, the four discrete numbers that are represented by the four tokens from the first set specify coordinates in the input image of two corners of the bounding box, e.g., the (x, y) coordinates of the upper left corner and the lower right corner or of the lower right corner and the upper left corner.

In some other cases, the four discrete numbers that are represented by the four tokens from the first set specify coordinates in the input image of the center of the bounding box and the height and width of the bounding box.

Thus, to generate the object detection output, the system can identify, for each subsequence in the output sequence, and from the tokens in the subsequence that belong to the first set of tokens, coordinates of the bounding box in the input image and then identify, as the respective object category to which the object depicted in the bounding box belongs, the object category represented by a token in the corresponding subsequence that belongs to the second set of tokens.

In other words, for each first token in the subsequence, the system can map the first token to the quantized coordinate value represented by the token to generate the coordinates that define the bounding box and, for each second token, the system can map the token to the label or other data that identifies the object category represented by the second token.

In some implementations, the system also associates the respective score assigned to the token that represents the respective object category for the bounding box in the score distribution at the corresponding time step with the bounding box to represent a confidence that the respective object category is a correct category for the object.

In some implementations, the system can refrain from including, in the object detection output, one or more bounding boxes, e.g., if the confidence score for the corresponding object category is below a threshold value.

The system can then output data identifying the object detection output, i.e., the bounding boxes, the object categories and, optionally, the associated confidence scores.

As a particular example, when the system is part of a perception system embedded within an agent, e.g., a robot or an autonomous vehicle, that processes images and optionally other sensor data collected by sensors of the agent the system can provide the data identifying the object detection output to the perception system or other software on-board the agent to control the agent as the agent navigates through the environment.

As another particular example, when the system is part of a perception system embedded within or in communication with a different type of device that processes sensor data, e.g., a camera monitoring system, a mobile phone, and so on, the system can output the data to another software component of the device for use in pre-processing the image before the image is displayed to a user or for use in automatically triggering an action, e.g., an alert.

As yet another particular example, when client devices can interact with the system through an application programming inference (API), e.g., a web-based API, the system can provide, in response to an API call, data identifying the object detection output. For example, the system can format the object detection output in a specified format, e.g., as a JavaScript Object Notation (JSON) file or as a file in another type of data-interchange format, and provide the file in response to the API call.

FIG. 3 shows example objection detection outputs that were extracted from output sequences generated by the object detection neural network.

In particular, FIG. 3 shows portions of example object detection outputs for three example input images 310, 320, and 330. Each portion includes the information that specifies one of the bounding boxes in the image.

As can be seen from FIG. 3, the system processes each of the input images 310, 320, and 330 using the neural network 110 to generate a respective output sequence and then extracts the corresponding object detection output portion 312, 314, and 316 from the output sequence for the input image.

For example, the object detection output portion 312 specifies that the bounding box has a lower right corner at y_min=9 and x_min=7 (in pixel coordinates), an upper right corner at y_max=67 and x_max=98, and is an image of an object that belongs to “the train” category. For example, when the tokens are represented as integers, images are 100×100, and each first token corresponds to one pixel of the image, the system can extract the objection detection output portion from the subsequence [9, 7, 67, 98, 115], where “115” is the token that represents the “train” category. That, is while the portion 312 is shown as including identifying information for each element, the underlying output sequence is only a sequence of discrete tokens from the vocabulary.

FIG. 4 is a flow diagram of an example process 400 for training the object detection neural network. For convenience, the process 400 will be described as being performed by a system of one or more computers located in one or more locations. For example, a training system, e.g., the object detection system 100 depicted in FIG. 1 or a different system of one or more computers in one or more locations, appropriately programmed in accordance with this specification, can perform the process 400.

The system can repeatedly perform iterations of the process 400 on different batches of training examples to train the neural network, i.e., to repeatedly adjust the values of the parameters of the neural network. That is, at each iteration of the process 400, the system obtains a batch of one or more training examples, e.g., by sampling the batch from a larger set of training data, and then performs an iteration of the process 400 to update the current values of the network parameters as of the iteration.

For example, the system can continue to perform iterations of the process 400 until a termination criterion has been satisfied, e.g., until a threshold number of training iterations have been performed, until a specified amount of time has elapsed, or until the parameters have been determined to converge.

The system obtains a batch of training examples (step 402). Each training example includes a training image and a target output that identifies one or more ground truth bounding boxes in the training image and a respective ground truth object category for each bounding box. The ground truth object category is an object category from the set of object categories to which the object depicted within the ground truth bounding box has been classified as belonging.

In some implementations, the system applies one or more augmentation techniques to generate the batch from an initial batch of training examples.

As one example, the system can generate one or more of the training images in the batch by applying one or more image augmentation policies to a corresponding initial training image. The system can then associate each generated training image with the target output for the corresponding initial training image. Applying the image augmentation policies can improve the robustness of the trained neural network to various image perturbations that may not be well represented in the training data.

For example, the image augmentation policies can specify how to apply random scaling, crops, or other image augmentation techniques to the initial training images to generate the batch of training examples.

As one example, the system can perform scale jittering with random crops on the initial training images. An example of such a technique is described in Golnaz Ghiasi, Yin Cui, Aravind Srinivas, Rui Qian, Tsung-Yi Lin, Ekin D Cubuk, Quoc V Le, and Barret Zoph. Simple copy-paste is a strong data augmentation method for instance segmentation. In Proceedings of the IEEE/CVF Conference on Computer Vision and Pattern Recognition, pp. 2918-2928, 2021.

As another example, the system can perform image scaling by resizing images (with a fixed aspect ratio) so that the longer side has a fixed number of pixels.

As another example, the system can apply color distortion to the intensity values of pixels in the initial training images. An example of such a technique is described in Andrew G Howard. Some improvements on deep convolutional neural network based image classification. arXiv preprint arXiv:1312.5402, 2013.

Instead of or in addition to the image augmentations, the system can also apply augmentations to the target outputs in the training examples to improve the robustness of the trained model to noisy predictions or mis-labeled training data.

For example, the system can select one or more of the initial ground truth bounding boxes in a particular initial training image in a particular one of the initial training examples, and then, for each selected initial ground truth bounding box, generate the corresponding ground truth bounding box in the corresponding training example by applying noise to the initial ground truth bounding box in the particular training image. For example, the system can apply a random scaling to the initial ground truth bounding box, can apply a random shift to the initial ground bounding box, or both.

For each training image, the system generates a target output sequence that includes, for each ground truth bounding box, a respective subsequence that includes (i) a set of first tokens that define a location of the bounding box in the image and (ii) a second token that represents the ground truth object category for the bounding box (step 404). That is, the target output sequence is made up of one or more subsequences, each corresponding to a different ground truth bounding box. Optionally, the last subsequence in the target output sequence can be followed by the end of sequence token, which is the last token in the target output sequence.

Because, at inference time, the order in which the bounding boxes are arranged in the output sequence generated by the neural network does not matter, i.e., an output that identifies bounding box A earlier in the sequence than bounding box B should be considered the same as an output that places bounding box B earlier in the sequence, the system can generate the target output sequence to reflect this. In particular, the system can order the respective subsequences in a random order within the target output sequence.

In some implementations, the system can also make one or more modifications to the target output sequence for any given training image to improve the performance of the neural network after training. As described above, when the neural network is trained using “teacher forcing,” the system also modifies the corresponding input sequence that is provided to the decoder neural network during training. Modifying the target output sequence (and, optionally, the corresponding input sequence) is referred to as “sequence augmentation.”

For example, as described above, in some implementations the vocabulary of tokens can include a token representing the “noise” object category that is not in the set of object categories. In these examples, the system can generate one or more random bounding boxes in the training image, and, for each random bounding box, include, in the target output sequence, a corresponding “noise” subsequence that includes (i) a set of first tokens that define a location of the random bounding box in the training image and (ii) a second token that represents the noise object category that is not in the set of object categories.

As a particular example, the system can add the noise subsequences after the last subsequence corresponding to any of the ground truth bounding boxes.

In some implementations, the system can add a fixed number of noise subsequences to each target output sequence. In some other implementations, the system can add noise subsequences so that each target output sequence includes the same, fixed number of subsequences (i.e., the same number of ground truth +noisy subsequences).

Adding these random (or “noisy”) bounding boxes into the target sequence can improve the performance of the trained neural network in a variety of ways. For example, some of these noise objects may be identical to, or overlapping with, some of the ground-truth objects, simulating noisy and duplicated predictions, i.e., thereby training the neural network to be more robust to these types of predictions in the training data. As another example, introducing the noisy bounding boxes into the target output sequences can prevent, at inference, the neural network from finishing without identifying all objects in the image without also introducing noisy and duplicated predictions into output generated as inference (as can occur when some other techniques, like artificially reducing the score assigned to the EOS token, are used).

The system then trains the object detection neural network to maximize, for each training image and for each token in at least a subset of the tokens in the target output sequence for the training image, a log likelihood of the token conditioned on any preceding tokens in the target output sequence and the training image (step 406).

When the target output sequence does not include noisy bounding boxes, the “at least a subset” above can include all of the tokens in the target output sequence. When the target output sequence does include noisy bounding boxes, the neural network is not trained to maximize the log likelihood of the tokens in the sets of first tokens for the random bounding boxes (but is trained to maximize the log likelihood of the second token that represents the noise category). That is, the “at least a subset” above includes all of the tokens except for the sets of first tokens for the random bounding boxes. This allows the neural network to learn to identify noise bounding boxes rather than mimic them.

In order to train the neural network to maximize the log likelihoods, the system computes, through backpropagation, gradients of an objective function that measures the log likelihoods of the at least the subset of the tokens with respect to the parameters of the encoder neural network and the decoder neural network and then updates the parameters using the determined gradients. For example, the system can apply an appropriate optimizer, e.g., the Adam optimizer, the rmsProp optimizer, the Adafactor optimizer, or a different machine learning optimizer, to the gradient and the parameters to update the parameters. For example, the loss function can be the average of, for each training example, a combination of, e.g., a sum or a weighted sum of, the log likelihoods for the training output sequence in the training example. When the target output sequence does include noisy bounding boxes, the sets of first tokens for the random bounding boxes are not included in the combination.

FIG. 5 shows an example of training the neural network for a given target output sequence.

In particular, FIG. 5 shows a first example 510 of training the neural network without sequence augmentation and second example 512 of training the neural network with sequence augmentation. More specifically, the first example 510 shows a target output sequence 520 and a corresponding input sequence 530. During training, the training system uses “teacher forcing,” so that the neural network processes the input sequence 530 to generate a respective score distribution for each position in the target output sequence 520 that is used for training the neural network as described above. Because of the “causality” employed by the decoder, the corresponding input sequence 530 is shifted by one token relative to the target output sequence 520, so that the respective score distribution for each given position in the target output sequence 520 depends on the tokens at positions preceding the given position in the target output sequence 520 (and an initial “start” token that is always provided as the first input at the first time step during auto-regressive generation at inference). This dependency is illustrated by the arrows in examples 510 and 512, with each token within a target output sequence depending on each token within the corresponding input sequence that is connected to the token by an arrow. i.e., the corresponding input sequence that is processed by the auto-regressive decoder at each generation time step.

In particular, in the first example 510, the target output sequence 520 includes ten tokens y1-y10, followed by the EOS token (“end”) without any additional tokens.

The second example 512 also includes a target output sequence 540 and a corresponding input sequence 550. However, in the target output sequence 540, the token y10 is followed by tokens for two “noise” bounding boxes. In particular, the target output sequence 540 includes two first sets of tokens that represent the coordinates of the noise bounding boxes, each of which is followed by a “noise” token that indicates that the bounding box is a noisy bounding box that was not originally present in the corresponding input image. Similarly, the corresponding input sequence 550 also includes additional tokens following the token y10. The first sets of tokens for the noisy bounding boxes are labeled as “n/a” in FIG. 5 because their log likelihoods are not considered, e.g., their loss is set to zero, when training the neural network.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, e.g., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, e.g., inference, workloads.

Machine learning models can be implemented and deployed using a machine learning framework, e.g., a TensorFlow framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A method performed by one or more computers, the method comprising:
obtaining an input image;
processing the input image using an object detection neural network to generate an output sequence that comprises respective token at each of a plurality of time steps, wherein each token is selected from a vocabulary of tokens that comprises (i) a first set of tokens that each represent a respective discrete number from a set of discretized numbers and (ii) a second set of tokens that each represent a respective object category from a set of object categories; and
generating, from the tokens in the output sequence, data identifying one or more bounding boxes in the input image and, for each bounding box, a respective object category from the set of object categories to which an object depicted in the bounding box belongs.

2. The method of claim 1, wherein the output sequence comprises a respective subsequence corresponding to each of the one or more bounding boxes, and wherein generating the data identifying the one or more bounding boxes comprises, for each bounding box:
identifying, from tokens in the corresponding subsequence that belong to the first set of tokens, coordinates of the bounding box in the input image; and
identifying, as the respective object category to which the object depicted in the bounding box belongs, the object category represented by a token in the corresponding subsequence that belongs to the second set of tokens.

3. The method of claim 2, wherein the respective subsequence includes four tokens from the first set of tokens and wherein the four discrete numbers that are represented by the four tokens specify coordinates in the input image of two corners of the bounding box.

4. The method of claim 2, wherein the respective subsequence includes four tokens from the first set of tokens and wherein the four discrete numbers that are represented by the four tokens specify coordinates in the input image of a center of the bounding box and a height and width of the bounding box.

5. The method of claim 1, wherein processing the input image using the object detection neural network comprises:
processing the input image using an encoder neural network to generate an encoded representation of the input image; and
processing the encoded representation of the input image using a decoder neural network to generate the output sequence.

6. The method of claim 1, wherein the object detection neural network is configured to generate a respective score distribution over the tokens in the vocabulary for each time step conditioned on (i) the input image and (ii) the tokens at any earlier time steps in the output sequence, and wherein processing the input image using the object detection neural network to generate an output sequence comprises, for each time step:
selecting the respective token at the time step in the output sequence using the respective score distribution generated by the object detection neural network for the time step.

7. The method of claim 6, wherein selecting the respective token comprises selecting the token with the highest score in the respective score distribution.

8. The method of claim 6, wherein selecting the respective token comprises sampling a token in accordance with the score distribution.

9. The method of claim 8, wherein selecting the respective token comprises sampling a token in accordance with the score distribution using nucleus sampling.

10. The method of claim 6, wherein the vocabulary comprises a noise token that represents a noise category that is not in the set of object categories, and wherein processing the input image using the object detection neural network to generate an output sequence comprises, for a particular one of the time steps:
determining that the token with the highest score for the particular time step is the noise token; and
in response, selecting, from only the tokens in the second set of tokens, the token with the highest score.

11. The method of claim 6, wherein processing the input image using the object detection neural network comprises:
processing the input image using an encoder neural network to generate an encoded representation of the input image; and
processing the encoded representation of the input image using a decoder neural network to generate the output sequence, and wherein the decoder neural network is configured to, for each time step:
process the tokens at any earlier time steps in the output sequence while conditioned on the encoded representation of the input image to generate the respective score distribution for the time step.

12. The method of claim 6, further comprising:
for each of the one or more bounding boxes, associating the respective score assigned to the token that represents the respective object category for the bounding box in the score distribution at the corresponding time step to represent a confidence that the respective object category is a correct category for the object.

13. The method of claim 1, further comprising:
outputting the data identifying the one or more bounding boxes in the input image and, for each bounding box, the respective object category from the set of object categories to which the object depicted in the bounding box belongs.

14. A method of training an object detection neural network, the method comprising:
obtaining a batch of training images and, for each training image, a target output that identifies one or more ground truth bounding boxes in the image and a respective ground truth object category for each bounding box;
for each training image, generating a target output sequence that includes, for each ground truth bounding box, a respective subsequence that includes (i) a set of first tokens that define a location of the bounding box in the image and (ii) a second token that represents the ground truth object category for the bounding box; and
training the object detection neural network to maximize, for each training image and for each token in at least a subset of the tokens in the target output sequence for the training image, a log likelihood of the token conditioned on any preceding tokens in the target output sequence and the training image.

15. The method of claim 14, wherein obtaining a batch of training images and, for each training image, a target output that identifies one or more ground truth bounding boxes in the image and a respective ground truth object category for each bounding box comprises:
generating one or more of the training images in the batch by applying one or more image augmentation policies to a corresponding initial training image.

16. The method of claim 14, wherein obtaining a batch of training images and, for each training image, a target output that identifies one or more ground truth bounding boxes in the image and a respective ground truth object category for each bounding box comprises:
for a particular bounding box in a particular training image, generating the bounding box by applying noise to an initial ground truth bounding box in the particular training image.

17. The method of claim 14, wherein for each training image, generating a target output sequence comprises:
generating one or more random bounding boxes in the training image; and
for each random bounding box, including, in the target output sequence, (i) a set of first tokens that define a location of the random bounding box in the training image and (ii) a second token that represents a noise object category that is not in the set of object categories.

18. The method of claim 17, wherein the object detection neural network is not trained to maximize the log likelihood of the tokens in the sets of first tokens for the random bounding boxes.

19. The method of claim 14, wherein for each training image, generating a target output sequence comprises:
ordering the respective subsequences in a random order within the target output sequence.

20. A system comprising:
one or more computers; and
one or more storage devices storing instructions that, when executed by the one or more computers, cause the one or more computers to perform operations comprising:
obtaining an input image;
processing the input image using an object detection neural network to generate an output sequence that comprises respective token at each of a plurality of time steps, wherein each token is selected from a vocabulary of tokens that comprises (i) a first set of tokens that each represent a respective discrete number from a set of discretized numbers and (ii) a second set of tokens that each represent a respective object category from a set of object categories; and
generating, from the tokens in the output sequence, data identifying one or more bounding boxes in the input image and, for each bounding box, a respective object category from the set of object categories to which an object depicted in the bounding box belongs.

21. (canceled)
